(19) United States
(12) Patent Application Publication
(10) Pub. No.: US 2024/0247733 A1
(43) Pub. Date: Jul. 25, 2024

(54) Automatic Gas Valve with Concentric Solenoid

(71) Applicants: Zachary Stephan Sandstrom, Itasca, IL (US); Brandon Heath Flanigan, Itasca, IL (US)

(72) Inventors: Zachary Stephan Sandstrom, Itasca, IL (US); Brandon Heath Flanigan, Itasca, IL (US)

(21) Appl. No.: 18/421,481

(22) Filed: Jan. 24, 2024

Related U.S. Application Data
(60) Provisional application No. 63/440,827, filed on Jan. 24, 2023.

(51) Int. Cl. F16K 31/10; F16K 17/04; F16K 31/06

(52) U.S. Cl. CPC F16K 31/10; F16K 17/04; F16K 31/0648; F16K 2200/201; F16K 2200/204; F16K 2200/302

(57) ABSTRACT

A valve with an inlet and an outlet has a solenoid valve as well as a pressure regulator within a housing. When the solenoid valve is off, no flow proceeds to the pressure regulator or outlet. When the solenoid valve is on, the pressure regulator functions as designed to regulate pressure out the outlet. The solenoid valve may have a seal acting on a second orifice and the pressure regulator may have a poppet acting on a first orifice. The first and second orifices may be parallel, colinear, and/or coaxial for many embodiments.

### CLAIM OF PRIORITY

This application claims the benefit of U.S. Provisional Application No. 63/440,827 filed Jan. 24, 2023, which is incorporated by reference herein in its entirety.

### FIELD OF THE INVENTION

The present invention relates to gas pressure regulators often utilized with gas appliances and more particularly to a gas pressure regulator having an ability to provide a gas tight seal and more particularly a gas pressure regulator having an integral redundant solenoid valve.

### BACKGROUND OF THE INVENTION

Gas pressure regulators have been manufactured by the applicant for years. These designs permit flow of gas at a particular pressure as set by the gas pressure regulator to therefore regulate the gas at a particular pressure as it proceeds from the inlet to the outlet of the regulator.

Many appliance manufacturers require a redundant seal to be present in a gas appliance so that if the gas regulator were to fail, such a failure would not result in a situation which could otherwise permit gas to be discharged through ports, or other locations, potentially into the living space of a user in an unwanted fashion. While solenoid gas open or shutoff valves have typically been installed downstream of gas pressure regulators, in such appliances there often remain potential leak points between a gas pressure regulator body and the body of the solenoid gas valve which are often spaced apart by piping, fittings, connections, etc.

Solenoid gas valves normally have a plunger which is normally biased shut or closed when de-energized against a valve seat. Upon energizing the solenoid, the plunger moves relative to an orifice (the valve seat) to thereby permit flow from inlet to the outlet of the valve. When the solenoid is de-energized the solenoid valve normally is in the shut configuration of an actuary a spring bias against the plunger thereby contacting the valve seat against the orifice.

Improvements such as applicant's U.S. Pat. No. 6,789,572, and others, have provided a compact valve/gas regulator combination, but further improvements are believed to be possible, at least for some applications.

### SUMMARY OF THE INVENTION

It is an object of many embodiments of the present invention to provide a single housing supporting a gas pressure regulator and a solenoid valve to provide a redundant seal.

It is an object of many embodiments of the present invention to provide a housing having a gas pressure regulator and an integral solenoid valve upstream of the gas pressure regulator.

It is another object of many embodiments of the present invention to provide a gas pressure regulator having a gas flow path through a regulated port opening which is concentrically disposed relative to a solenoid valve to provide a redundant seal spaced apart from the poppet seal of the gas pressure regulator such as may be used in various gas appliances.

It is another object of many embodiments of the present invention to provide a housing having an inlet and an outlet with a gas pressure regulator having a poppet which can be closed against a first orifice to provide a seal with the first orifice concentrically disposed spaced-apart from, and/or parallel, to a second orifice having a valve seat of a solenoid valve.

Accordingly, in accordance with a presently preferred embodiment of the present invention, a housing has an inlet and an outlet with a gas pressure regulator there between. Specifically, a poppet is moveable relative to a first orifice on the inlet side of the orifice. A spring biased diaphragm normally displaces the poppet apart from the orifice to permit gas flow until the pressure on the inlet side exceeds a predetermined amount, and then bias is overcome to have the poppet seal off the first orifice opening. This is a gas pressure regulator. If the gas pressure on the inlet side is too high, then the spring force is overcome, and the poppet seals shut the first orifice and the flow of gas. If the gas pressure is not too high and does not exceed the amount of pressure permitted by the regulator, then the poppet is held spaced apart from the first orifice allowing for gas flow through the first orifice and out the outlet. That type structure has been utilized by gas appliance for decades.

What is new for many embodiments is that the housing supporting the inlet and the outlet also has a separate solenoid valve therein with an actuator moving relative to a second orifice to provide an on/off condition. The actuator seals against the second orifice in the closed (often off) at the valve seat and is spaced apart from the second orifice in the open configuration. When in an energized state, the actuator is pulled away from the second orifice thereby permitting gas to flow through the second orifice. The gas regulator performs its normal regulating function in this condition. Upon power being secured to the solenoid valve, then bias against the actuator moves the actuator against the valve seat of the second orifice to shut off the gas flow through the second orifice to provide a redundant seal so that no gas flows to the gas pressure regulator in the absence of the solenoid being activated.

An improvement of many embodiments of this current design is that the significant less amount of equipment and machine is required with the new design than the old. Specifically, for at least some embodiments, the solenoid valve can be oriented so that it is solenoid piston is colinearly disposed with the piston supporting the poppet of the gas pressure regulator for at least some preferred embodiments. The first and second orifices may be coaxially oriented, spaced-apart, and parallel for many embodiments, possibly with the solenoid valve seat located upstream of the gas pressure regulator.

### BRIEF DESCRIPTION OF THE DRAWINGS

The particular features and advantages of the inventions with other objects will become apparent from the following description taken in connection with the accompanying drawings in which:

FIG. 1 is a cutaway view of a presently preferred embodiment of the present invention in an on or open configuration permitting gas regulation by the gas regulator; and

FIG. 2 is a schematic view of detail A of FIG. 1 in a shut or closed configuration.

### DETAILED DESCRIPTION OF THE PREFERRED EMBODIMENT

Gas valve 10 is a dual function valve with a gas pressure regulator 20 and a separate solenoid valve 22 located in detail A. Valve 10 has an inlet 12 and an outlet 14 preferably machined into a housing 16. A poppet 18 is preferably moveable relative to an orifice 24 so as to permit the flow of gas between the inlet 12 and the outlet 14. The gas pressure regulator 20 can operate similar to many other gas pressure regulators available in the market. Specifically, a diaphragm 26 connects is spring biased such as by one or more springs 28, 30.

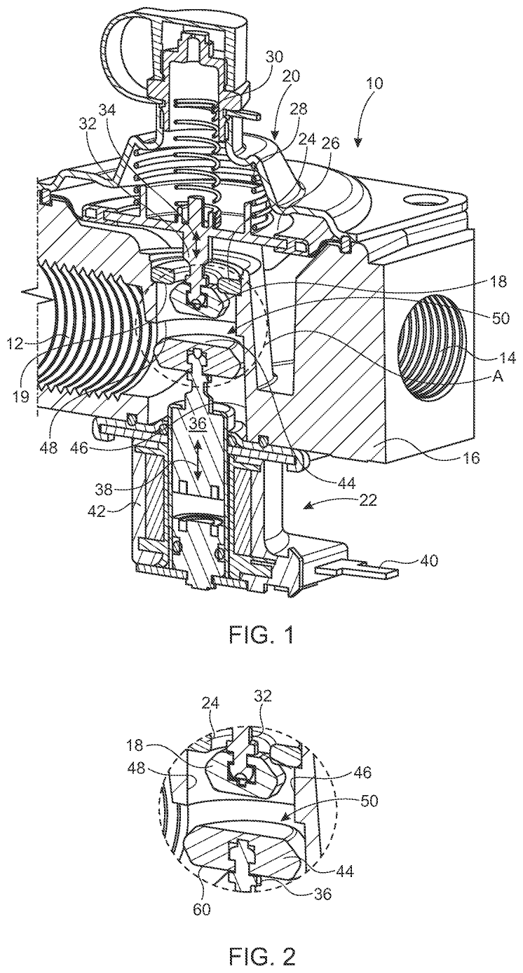

The gas pressure regulator may use a piston 32 extending from the diaphragm 26 to support the poppet 18 preferably in an initially open configuration regulative to the first orifice 24 with the gas pressure regulator 20 set to a predetermined pressure such as those traditionally utilized in gas appliances. Should the pressure at the inlet 12 exceed the designed pressure, then the poppet 18 seals against the first orifice 24 to provide a seal. When the pressure at inlet 12 is less than the preset pressure of the regulator 20, then the poppet 18 moves to the open configuration such as shown in FIG. 1. One of ordinary skill will understand that the poppet 18 moves along axis 34 between the open and closed configuration. Other gas pressure regulators (GPRs) 20 may operate differently but otherwise move a poppet 18 relative to a first orifice 24 to provide a valve seat 15 in a closed configuration at opening or first orifice 20. In an open configuration, the flow of gas is permitted between the inlet 12 and the outlet 14 through the first orifice 24.

What differentiates many embodiments the valve 10 from prior art designs is that a solenoid valve 22 has a plunger 36 which moves along axis 38 between an open position, such as the one illustrated, with sufficient power being provided at power connection 40, or other appropriate connections to energize solenoid 42 to initially overcome bias of spring (not illustrated) so that a seal 44 can initially be moved off of the valve seat 48. Seal 44 may secure flow through second orifice 50 with the pressure solenoid 42 de-energized. If energized, the pressure regulator 20 is allowed to function in its normal configuration. However, upon transitioning the solenoid assembly 22 to an off configuration normally by securing power such as at the power connection 40 then the solenoid 42 would de-energize allowing the plunger 36 to extend as forced by spring bias of spring 60 so that the seal 44 would then seat against the valve seat 48 to secure flow through the second orifice 50.

Note that for the preferred embodiment, the axis 38 is the axis of the plunger 36 as well as the solenoid 42 and the solenoid assembly 22 for many embodiments. Thus, any of these solenoid axes 38 may be colinear with the gas pressure regulator piston 32 axis 34 which moves the poppet 18. Other embodiments may not require these two axes 34,38 to be colinear, possibly while still being parallel.

Solenoid assembly 22 may have the solenoid 42 located at least external to the housing 16 and extending through a bore 46 in the housing 16 allowing the plunger 36 to extend through the bore 46 with the bore 46 being coaxially disposed relative to the opening 24 for many embodiments. The diaphragm 26 and springs 28,30,44 may also be coaxially disposed relative to the opening 24 and the bore 46 for many embodiments. Other embodiments may not provide this coaxial/colinear arrangement.

Such a construction provides a redundant gas seal when the solenoid is in the off position which may be required by at least some gas appliance manufacturers.

The first orifice 24 is preferably spaced apart and parallel to second orifice 50. Second orifice 50 is preferably upstream of first orifice 24 (i.e., closer to inlet 12 than second orifice 24).

Numerous alterations of the structure herein disclosed will present themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having set forth the nature of the invention, what is claimed herein is:

1. A gas valve with regulator comprising:
a housing having a gas inlet and a gas outlet;
a gas pressure regulator having a first orifice located intermediate the gas inlet and gas outlet in the housing;
a solenoid operated valve acting on a second orifice located intermediate the gas inlet and gas outlet in the housing and disposed in series with the gas pressure regulator closer to the gas inlet than the first orifice, said solenoid operated valve selectively operable to either permit flow through the second orifice in an on configuration or prevent flow through the second orifice in an off configuration.

2. The gas valve of claim 1 wherein the first and second orifices are located in first and second planes respectively and the first and second planes are parallel.

3. The gas valve of claim 1 wherein the first and second orifices are coaxially oriented relative to each other.

4. The gas valve of claim 1 wherein the first and second or orifices are co-linearly disposed relative to one another.

5. The gas valve of claim 1 wherein the gas pressure regulator has a poppet moveable relative to the first orifice.

6. The gas valve of claim 5 wherein the gas pressure valve has a spring based diaphragm acting on the poppet, and when the pressure exceeds a predetermined amount, the poppet seals against the first orifice, and when the pressure is below the predetermined amount, the poppet is displaced from the first orifice.

7. The gas valve of claim 6 wherein the gas pressure valve has a piston extending from the diaphragm to the poppet.

8. The gas valve of claim 5 wherein the solenoid operated valve has a plunger connected to a seal movable relative to the second orifice whereby the seal is against the second orifice in the off configuration and the seal is displaced from the second orifice in the on configuration.

9. The gas valve of claim 8 wherein the plunger moves along a solenoid axis, and the pressure regulator has a plunger connected to the poppet, and the plunger moves along a plunger axis and the solenoid axis and the plunger axis are colinear.

10. The gas valve of claim 9 wherein the first and second orifices are coaxially oriented relative to each other.

11. The gas valve of claim 5 wherein the first and second orifices are located in first and second planes respectively and the first and second planes are parallel.

12. The gas valve of claim 5 wherein the gas pressure regulator has a poppet moveable relative to the first orifice.

13. The gas valve of claim 1 wherein the solenoid valve is biased to the off configuration, whereby upon securing an electrical signal to the solenoid valve, the valve either moves to the off configuration or remains in the off configuration.

14. The gas valve of claim 13 wherein sufficient electrical input causes the solenoid valve to be in the open configuration.

15. The gas valve of claim 1 wherein the solenoid operated valve has a plunger connected to a seal movable relative to the second orifice whereby the seal is against the second orifice in the off configuration and the seal is displaced from the second orifice in the on configuration.

16. The gas valve of claim 15 wherein the plunger moves along a solenoid axis, and the pressure regulator has a plunger connected to a poppet, and the plunger moves along a plunger axis and the solenoid axis and the plunger axis are colinear.

17. The gas valve of claim 16 wherein the first and second orifices are coaxially oriented relative to each other.

18. The gas valve of claim 17 wherein the solenoid valve is biased to the off configuration, whereby upon securing an electrical signal to the solenoid valve, the valve either moves to the off configuration or remains in the off configuration.

19. The gas valve of claim 18 wherein sufficient electrical input moves the solenoid valve to the open configuration.

20. The gas valve of claim 19 wherein the gas pressure regulator has a poppet moveable relative to the first orifice.
